(19) United States
(12) Patent Application Publication
(10) Pub. No.: US 2023/0401805 A1
(43) Pub. Date: Dec. 14, 2023

(54) Merged 3D Spaces During Communication Sessions

(71) Applicant: Apple Inc., Cupertino, CA (US)

(72) Inventors: Hayden J. Lee, Palo Alto, CA (US); Connor A. Smith, San Mateo, CA (US)

(21) Appl. No.: 18/205,591

(22) Filed: Jun. 5, 2023

Related U.S. Application Data
(60) Provisional application No. 63/350,195, filed on Jun. 8, 2022.

(51) Int. Cl. G06T 19/20; G06T 15/20

(52) U.S. Cl. CPC G06T 19/20; G06T 15/20; G06T 2219/2004; G06T 2219/024

(57) ABSTRACT

Various implementations disclosed herein include devices, systems, and methods that provide a communication session in which the participants view an extended reality (XR) environment that represents a portion of a first user's physical space merged with a portion of a second user's physical space. The respective spaces are aligned based on selected vertical surface (e.g., walls) within each physical environment. For example, each user may manually select a respective wall of their own physical room and each may be presented with a view in which the two rooms appear to be stitched together along the selected walls. In some implementations, the rooms are aligned and merged to give the appearance that the walls were knocked down/erased and turned into portals into the other user's room.

### CROSS-REFERENCE TO RELATED APPLICATIONS

This application claims the benefit of U.S. Provisional Application Ser. No. 63/350,195 filed Jun. 8, 2022, which is incorporated herein in its entirety.

### TECHNICAL FIELD

The present disclosure generally relates to electronic devices that provide views of 3D environments that include content that may be at least partially shared amongst multiple users, including views in which content from different physical environments appears to be combined together within a single environment.

### BACKGROUND

Various techniques are used to enable people to share audio, images, and 3D content during communication sessions. However, existing systems may not provide shared 3D environments having various desirable attributes.

### SUMMARY

Various implementations disclosed herein include devices, systems, and methods that provide a communication session in which the participants view an extended reality (XR) environment that represents a portion of a first user's physical environment merged with a portion of a second user's physical environment. The respective portions are aligned based on at least one selected surface (e.g., wall) within each physical environment. For example, each user may manually select a respective wall of their own physical room and then each user may be presented with a view in which the two rooms appear to be stitched together based on the selected walls. In some implementations, the rooms are aligned and merged to give the appearance that the selected walls were knocked down/erased and turned into portals into the other user's room. Using selected surfaces to align merged spaces in combined XR environments may provide advantages including, but not limited to, improving realism or plausibility, limiting the obstruction of content within each user's own physical space, improving symmetry of walls and content, and providing an intuitive or otherwise desirably-positioned boundary between merged spaces.

In some implementations a processor performs a method by executing instructions stored on a computer readable medium. The method obtains an indication of a first surface of a first physical environment, the first physical environment comprising a first device. the method obtains a 3D alignment between a representation of the first physical environment obtained via sensor data of the first device and a representation of a second physical environment obtained via sensor data of a second device, the second physical environment comprising the second device. The alignment aligns a portion of the representation of the first physical environment corresponding to the first surface with a portion of the representation of the second physical environment corresponding to a second surface of the second physical environment. The method provides a view of an extended reality (XR) environment during a communication session, the XR environment comprising the representation of the first physical environment and the representation of the second physical environment aligned according to the obtained 3D alignment.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIGS. 1A and 1B illustrate exemplary electronic devices operating in different physical environments in accordance with some implementations.

FIGS. 2A and 2B illustrate the shapes of portions of the physical environments of FIGS. 1A and 1B respectively, in accordance with some implementations.

FIGS. 2C and 2D illustrate an exemplary alignment of the portions of the physical environments of FIGS. 2A and 2B in accordance with some implementations.

FIG. 3 illustrates an XR environment combining the portions of the physical environments according to the alignment illustrated in FIGS. 2C-2D, in accordance with some implementations.

FIG. 4 illustrates an exemplary view of the XR environment of FIG. 3 provided by the electronic device of FIG. 1A, in accordance with some implementations.

FIG. 5 illustrates an exemplary view of the XR environment of FIG. 3 provided by the electronic device of FIGS. 1B, in accordance with some implementations.

FIG. 6 illustrates an exemplary alignment of spaces from different physical environments in accordance with some implementations.

FIGS. 7A, 7B, and 7C illustrate additional example alignments of spaces from different physical environments in accordance with some implementations.

FIG. 8 is a flowchart illustrating a method for providing a view of an XR environment that represents a portion of a first user's physical space merged with a portion of a second user's physical space, in accordance with some implementations.

FIG. 9 is a block diagram of an electronic device of in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

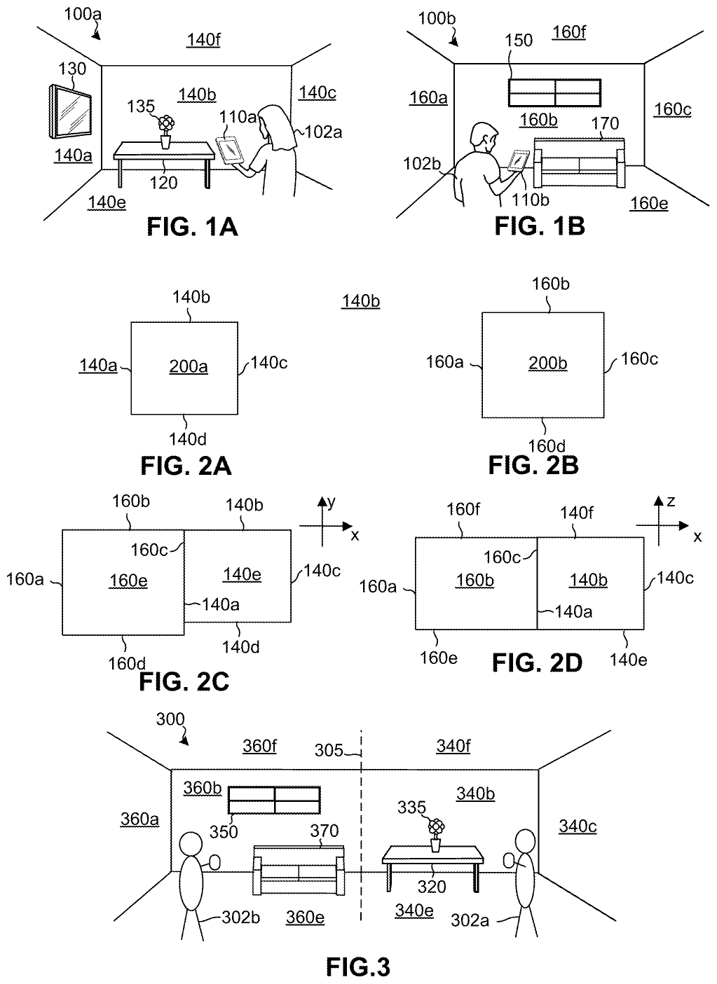

FIGS. 1A and 1B illustrate exemplary electronic devices 110a, 110b operating in different physical environments 100a, 100b. Such environments may be remote from one another, e.g., not located within the same room, building, complex, town, etc. In FIG. 1A, the physical environment 100a is a room that includes a first user 102a, the first user's table 120, the first user's TV 130, and the first user's flowers 135. The physical environment 100a includes walls 140a, 140b, 140c, 140d (not shown), floor 140e, and ceiling 140f. In FIG. 1B, the physical environment 100b is a different room that includes a second user 102b, the second user's couch 170 and the second user's window 150. The physical environment 100b includes walls 160a, 160b, 160c, 160d (not shown), floor 160e, and ceiling 160f.

The electronic devices 110a-b may each include one or more cameras, microphones, depth sensors, or other sensors that can be used to capture information about and evaluate their respective physical environments 100a-b and the objects within those environments 100a-b, as well as information about the users 102a-b, respectively. Each device 110a-b may use information about its respective physical environment 100a-b and user 102a-b that it obtains from its sensors to provide visual and audio content and/or to share content during a communication session.

FIGS. 2A-2D provide 2D representations that illustrate a 3D alignment of portions of the physical environments 100a-b of FIGS. 1A and 1B. FIGS. 2A and 2B illustrate the wall-based boundaries of portions of the physical environments of FIGS. 1A and 1B respectively. In this example, FIG. 1A depicts a portion of physical environment 100a that is a room having four walls 140a-d. FIG. 2A illustrates a top-down (x/y), floorplan-like view illustrating shape of this four-wall room. Similarly, FIG. 1B depicts a portion of physical environment 100b that is also a room having four walls 160a-d. FIG. 2B illustrates a top-down (x/y), floorplan-like view illustrating shape of this four-wall room.

FIG. 2C illustrates an exemplary alignment of the portions of the physical environments using a top-down (x/y), floorplan like views of FIGS. 2A and 2B. In particular, wall 140a is aligned with wall 160c. In this example, these walls 140a, 160c are aligned to overlap at least partially, i.e., they overlap along at least segments of each wall. Moreover, the walls 160b and 140b are aligned adjacent to one another on the same plane (shown along the same line in FIG. 2C). The exemplary alignment is provided for illustrative purposes and other types of overlapping alignments and non-overlapping alignments may alternatively be implemented. For example, walls 140a, 160c may be aligned to be on parallel but separate planes, e.g., planes separated by 1 foot, 2 feet, etc.

The alignment between walls 140a, 160c (or other walls) may be based on an automatic or manual selection of these walls to be aligned. For example, user 102a may provide input selecting wall 140a and user 102b may provide input selecting wall 160c. In some implementations, a recommended wall is automatically determined and suggested based on criteria (e.g., identifying the largest wall, the wall with the most open space, the wall oriented in front of seats or furniture, the wall that was recently selected, etc.). Such a recommended wall may be identified to the user as a suggestion to use and then confirmed (or changed) based on user input.

FIG. 2D illustrates the exemplary alignment of FIG. 2C using a side (x/z) view. In this example, the aligned walls 140a, 160c again overlap. The floors 160e, 140e are also aligned to be on the same plane (shown along the same line in FIG. 2D). In some implementations, such a floor-to-floor alignment is automatically used whenever possible, e.g., whenever both rooms have flat, level floor surfaces. In this case, the floors 160e, 140e are automatically aligned and, since the rooms are the same heights, the ceilings 160f, 140f are also aligned (shown along the same line in FIG. 2D).

In some implementations, an alignment between 3D spaces is determined automatically based on an automatic or manual identification of a single vertical wall in each physical environment 100a-b and one or more alignment criteria. For example, given a wall selected in each physical environment, such criteria may require (a) aligning the floor surfaces of the spaces to be on a single plane (2) positioning the spaces relative to one another to maximize area of the selected walls that overlap one another (3) positioning the spaces so that the centers of the selected walls overlap one another or (4) positioning the spaces so that additional walls (e.g., walls 140b, 160b) align (e.g., are on the same plane) as one another, or some combination of these or other alignment criteria.

FIG. 3 illustrates an XR environment 300 combining the portions of the physical environments 100a-b according to the alignment illustrated in FIGS. 2C-D. In this example, the XR environment 300 includes a depiction 302b of the second user 102b, a depiction 370 of the second user's couch 170, a depiction 350 of the second user's window 150, depictions 360a, 360b, 360d (not shown) of walls 160a, 160b, 160d, a depiction 360f of ceiling 160f and a depiction 360e of floor 160e. The XR environment 300 also includes a depiction 302a of the first user 102a, a depiction 320 of the first user's table 120, a depiction 335 of the first user's flowers 135, depictions 340b, 340c, 340d (not shown) of walls 140b, 140c, 140d, a depiction 340f of ceiling 140f and a depiction 340e of floor 140e.

The aligned walls 140a, 160c are not depicted in FIG. 3. Rather these aligned/overlapping walls are erased/excluded. Instead, the XR environment includes a portal 305 (e.g., an invisible or graphically visualized planar boundary region) between the depictions of content from the physical environments 100a-b. In some implementations, portal 305 does not include any visible content. In other implementations, graphical content is added, e.g., around the edges of the portal 305 to identify its location with the XR environment.

FIG. 3 also illustrates how the depictions 360b, 340b of walls 160b, 140b are aligned within the XR environment 300. These depictions 360b, 340b are aligned to be on the same plane and abutting one another at the portal 305. Similarly, depictions 360e, 340e of floors 160e, 140e are also aligned to be on the same plane and abutting one another at the portal 305. Similarly, depictions 360f, 340f of ceilings 160f, 140f are also aligned to be on the same plane and abutting one another at the portal 305.

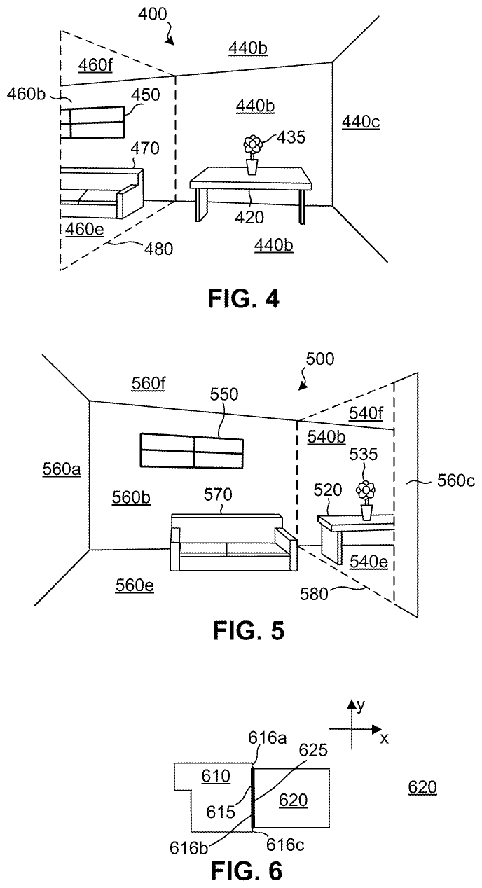

FIG. 4 and FIG. 5 illustrate the exemplary electronic devices 110a-b of FIGS. 1A and 1B providing views 400, 500 to their respective users 102a-b. In this example, each of the devices 110a, 110b provides a respective view of the same shared XR environment 300 of FIG. 3. These views may be provided based on viewpoint positions within the XR environment 300 that are determined based on the positions of the devices 110a-b in the respective physical environments, e.g., as the devices 110a-b are moved within the physical environments 100a-b, the viewpoints may be moved in corresponding directions, rotations, and amounts in the XR environment 300. The viewpoints may correspond to avatar positions within the XR environment 300. For example, user 102a may be depicted in the XR environment by depiction 302a and may see a view of the XR environment 300 that is based on that viewpoint position.

FIG. 4 illustrates an exemplary view 400 of the XR environment of FIG. 3 provided by the electronic device 100a of FIG. 1A. In this example, the view 400 includes a depiction 420 of the first user's table 120, a depiction 435 of the first user's flowers 135, depictions 440b, 440c of walls 140b, 140c, a depiction 440f of ceiling 140f and a depiction 440e of floor 140e. In some implementations, these depictions 420, 435, 440b, 440c, 440f, 440e may be displayed on a display (e.g., based on image or other sensor data captured by device 102a of physical environment 100a), e.g., as pass-through video images. In some implementations, these depictions 420, 435, 440b, 440c, 440f, 440e may be provided by an optical-see-through technique in which the user 102a is enabled to see the corresponding objects directly, e.g., through a transparent lens.

The view 400 additionally includes depictions of content from the second user's environment 100b that are included in the XR environment 300. In particular, the view 400 includes a depiction 470 of the second user's couch 170, a depiction 450 of the second user's window 150, a depiction 460b of the wall 160b, a depiction 460e of the floor 160e, and a depiction 460f of the ceiling 160f. These depictions 470, 450, 460b, 460e, 460f may be displayed on a display or otherwise added (e.g., as augmentations or replacement content) based on image or other sensor data captured by device 102b of the physical environment 100b). In some implementations, these depictions are displayed as image content on a portion (e.g., a lens) of a see-through device, e.g., as images produced by directing light through a waveguide into a lens and towards the user's eye such that the user views the depictions in place of the portion of the physical environment (e.g., wall 140a) that would otherwise be visible.

In the example of FIG. 4, the view 400 presents the XR environment 300 such that on one side of the portal 480, the view 400 includes depictions 420, 435, 440b, 440c, 440f, 440e corresponding to a space of physical environment 100a and, on the other side of the portal 480, the view includes depictions 470, 450, 460b, 460e, 460f corresponding to the space of physical environment 100b. In this example, the view 400 provides the perception that these spaces have been merged with one another at the boundary (illustrated as portal 480).

The view 400 excludes a depiction of some or all of wall 140a and objects hanging from or otherwise near that wall 140a, e.g., TV 130. In some implementations, objects that are within a threshold distance (e.g., 3 inches, 6 inches, 12 inches, etc.) of a selected wall are excluded. In some implementations, wall hanging objects (e.g., pictures, TVs, mirrors, shelves, etc., are identified (e.g., via computer vision) and excluded from the view 400. Various criteria, e.g., based on object type, object relationship to the wall, distance, etc., may be used to determine objects to be excluded from the XR environment 300 and the views of the XR environment 300.

The alignment of the spaces in this way (e.g., at a portal 480 defined by selected vertical surfaces, with floor surfaces aligned, etc.) may provide one or more advantages. The alignment may provide a relatively simple and intuitive separation of depictions of a user 102a's own space and depictions of the second user's space that have been merged with it. Little or none of the first user's environment 100a is obstructed in this view 400, e.g., only wall 140a and TV 130 are excluded.

Although not shown, the view 400 could include a depiction of user 102b, for example, if user 102b were to walk and sit on the right side of couch 170. Such a depiction of user 102b could be based on image data of the user 102b and thus could be a relatively realistic representation of user 102b. Such a depiction may be based on information shared from device 110b, e.g., based on a stream of live images or other data corresponding to at least a portion of the user 102b that device 110b sends to device 110a during a communication session, or on information on device 110a, e.g., based on a previously-obtained user representation of user 102b. As the user 102b moves around, makes hand gestures, and makes facial expression, corresponding movements, gestures, and expressions may be displayed for the depiction of the user 102b in the view 400. For example, as the user 102b moves sits down on couch 170 in physical environment 100b, the view 400 may show a depiction of the user 102b sitting down on the depiction 470 of the couch 170.

Audio, including but not limited to words spoken by user 102b, may also be shared from device 110b to device 110a and presented as an audio component of view 400.

FIG. 5 illustrates an exemplary view 500 of the XR environment of FIG. 3 provided by the electronic device 102b of FIG. 1B. In this example, the view 500 includes a depiction 570 of the second user's couch 170, a depiction 550 of the second user's window 150, depictions 560a, 560b of walls 160a, 160b, a depiction 560f of ceiling 160f and a depiction 560e of floor 160e. In some implementations, these depictions 570, 550, 560a, 560b, 560f, 560e may be displayed on a display (e.g., based on image or other sensor data captured by device 102b of physical environment 100b), e.g., as pass-through video images. In some implementations, these depictions 570, 550, 560a, 560b, 560f, 560e may be provided by an optical-see-through technique in which the user 102b is enabled to see the corresponding objects directly, e.g., through a transparent lens.

The view 500 additionally includes depictions of content from the first user's environment 100a that are included in the XR environment 300. In particular, the view 500 includes a depiction 520 of the first user's table 120, a depiction 535 of the first user's flowers 135, a depiction 540b of the wall 140b, a depiction 540e of the floor 140e, and a depiction 540f of the ceiling 140f. These depictions 520, 535, 540b, 540e, 540f may be displayed on a display or otherwise added (e.g., as augmentations or replacement content) based on image or other sensor data captured by device 102a of the physical environment 100a). In some implementations, these depictions are displayed as image content on a portion (e.g., a lens) of see-through device, e.g., as images produced by directing light through a waveguide into a lens and towards the user's eye such that the user views the depictions in place of the portion of the physical environment (e.g., wall 160c) that would otherwise be visible.

In the example of FIG. 5, the view 500 presents the XR environment 300 such that on one side of the portal 580, the view 500 includes depictions 570, 550, 560a, 560b, 560f, 560e corresponding to a space of physical environment 100b and, on the other side of the portal 580, the view 500 includes depictions 520, 535, 540b, 540e, 540f corresponding to the space of physical environment 100a. The view 500 provides the perception that these spaces have been merged with one another at the boundary (illustrated as portal 580). The alignment of the spaces in this way (e.g., at a portal 580 defined by selected vertical surfaces, with floor surfaces aligned, etc.) may provide one or more advantages. The alignment may provide a relatively simple and intuitive separation of depictions of user 102b's own space and depictions of the first user 102a's space that has been merged with it. Little or none of the second user's environment 100b is obstructed in this view 500, e.g., only a portion of wall 160c.

Note that a depiction 560c of a portion of wall 160c is displayed in the view 160. In this example, the size of the portal is based on the amount of overlap of walls 140a and 160c in the alignment. Since wall 140a is smaller than wall 160c, a portion of the wall 160c that is outside of the portal is included in the view 500.

Although not shown, the view 500 could include a depiction of user 102a, for example, if user 102a were to interact with the first user's flowers 135. Such a depiction of user 102a could be based on image data of the user 102a and thus could be a relatively realistic representation of user 102a. Such a depiction may be based on information shared from device 110a, e.g., based on a stream of live images or other data corresponding to at least a portion of the user 102a that device 110a sends to device 110b during a communication session, or on information on device 110b, e.g., based on a previously-obtained user representation of user 102a. As the user 102a moves around, makes hand gestures, and makes facial expression, corresponding movements, gestures, and expressions may be displayed for the depiction of the user 102a in the view 500. For example, as the user 102b moves plucks a petal from the first user's flowers 135 in physical environment 100a, the view 500 may show a depiction of the user 102a plucking a flower from depiction 535 of the first user's flowers 135.

Audio, including but not limited to words spoken by user 102a, may also be shared from device 110a to device 110b and presented as an audio component of view 500.

In the example of FIGS. 1-5, the electronic devices 110a-b are illustrated as hand-held devices. The electronic devices 110a-b may be a mobile phone, a tablet, a laptop, so forth. In some implementations, electronic devices 110a-b may be worn by a user. For example, electronic devices 110a-b may be a watch, a head-mounted device (HMD), head-worn device (glasses), headphones, an ear mounted device, and so forth. In some implementations, functions of the devices 110a-b are accomplished via two or more devices, for example a mobile device and base station or a head mounted device and an ear mounted device. Various capabilities may be distributed amongst multiple devices, including, but not limited to power capabilities, CPU capabilities, GPU capabilities, storage capabilities, memory capabilities, visual content display capabilities, audio content production capabilities, and the like. The multiple devices that may be used to accomplish the functions of electronic devices 110a-b may communicate with one another via wired or wireless communications.

FIG. 6 illustrates an exemplary alignment of spaces from different physical environments. In this example, the wall-based boundaries of spaces 610, 620 of different physical environments are aligned and depicted in a top-down (x/y), floorplan like view. FIG. 6 illustrates an exemplary alignment. In particular, a selected vertical surface 615 of portion 610 is aligned with a vertical surface 625 of portion 620. Since vertical surface 615 is larger than vertical surface 625, some of vertical surface 615 does not overlap with vertical surface 625. In this example, the centers of the vertical surfaces 615, 625 are aligned such that a center portion 616b of vertical surface 615 overlaps with vertical surface 625 and side portions 616a, 616c of vertical surface 615 do not overlap with vertical surface 625. The alignment provides for the location of a portal between the spaces 610, 620 at the location of the overlap.

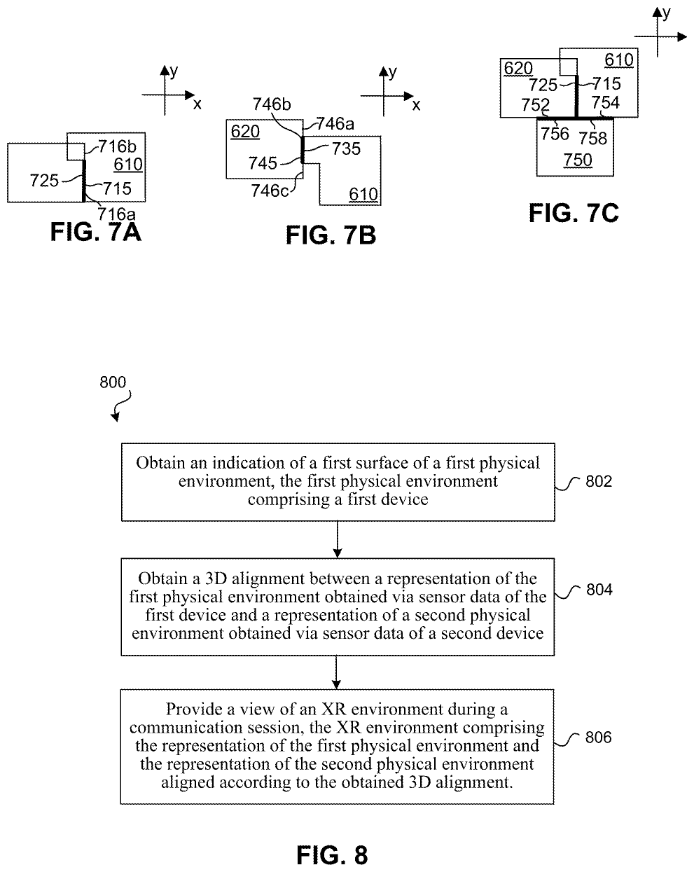

FIGS. 7A and 7B illustrate additional example alignments of spaces from different physical environments. In FIG. 7A, the wall-based boundaries of spaces 610, 620 of different physical environments are aligned and depicted in a top-down (x/y), floorplan like view. FIG. 7A illustrates an exemplary alignment. In particular, a selected vertical surface 715 of portion 610 is aligned with a vertical surface 725 of portion 620. Since vertical surface 725 is larger than vertical surface 715, some of vertical surface 725 does not overlap with vertical surface 715. In this example, a first portion 716a of vertical surface 725 overlaps with vertical surface 715 and a side portion 716b of vertical surface 725 does not overlap with vertical surface 715. The alignment provides for the location of a portal between the spaces 610, 620 at the location of the overlap. In this example, the physical environments also partially overlap. In some implementations, an alignment that provides an overlapping physical environment area is used to merge the spaces according to a rule that specifies how overlapping space will be treated. For example, the overlapping space may include only visible content from each user's environment for that user's view of the merged space. In another example, each user can see the overlapping portion from the other physical environment when viewing that portion through the portal (e.g., the space looks different when viewed directly than when looking through the portal).

In FIG. 7B, the wall-based boundaries of spaces 610, 620 of different physical environments are aligned and depicted in a top-down (x/y), floorplan like view. FIG. 7B illustrates an exemplary alignment. In particular, a selected vertical surface 735 of portion 610 is aligned with a vertical surface 745 of portion 620. Since vertical surface 745 is larger than vertical surface 735, some of vertical surface 745 does not overlap with vertical surface 735. In this example, the centers of the vertical surfaces 735, 745 are aligned such that a center portion 746b of vertical surface 745 overlaps with vertical surface 735 and side portions 746a, 746c of vertical surface 745 do not overlap with vertical surface 735. The alignment provides for the location of a portal between the spaces 610, 620 at the location of the overlap.

While examples above show the merging of 2 spaces, the disclosed techniques can be applied to merge more than 2 spaces, e.g., 3, 4, 5, or more spaces. In some implementations, one surface may display a first portal into a first space and a second portal to a second space. In some implementations, a first surface may display a first portal to a first space and a second surface may display a portal to a second space, etc. For example, FIG. 7C, illustrates a merging of three physical environments 610, 620, 750. In this example, a portal at the boundary between vertical surface 715 and vertical surface 725 is used to merge physical environment 610 with physical environment 620, a portal at the boundary between vertical surface 752 and vertical surface 756 is used to merge physical environment 620 with physical environment 750, and a portal at the boundary between vertical surface 754 and vertical surface 758 is used to merge physical environment 610 with physical environment 620 for merging,

While vertical surfaces were used in the above examples, other non-vertical or non-planar surfaces may be used as boundaries or portals for merging spaces.

FIG. 8 is a flowchart illustrating a method 800 for providing a view of an XR environment that represents a portion of a first user's physical space merged with a portion of a second user's physical space. In some implementations, a device such as electronic device 110a or electronic device 110b, or a combination of the two, performs method 800. In some implementations, method 800 is performed on a mobile device, desktop, laptop, HMD, ear-mounted device or server device. The method 800 is performed by processing logic, including hardware, firmware, software, or a combination thereof. In some implementations, the method 800 is performed on a processor executing code stored in a non-transitory computer-readable medium (e.g., a memory).

At block 802, the method 800 obtains an indication of a first surface of a first physical environment, the first physical environment comprising the first device. Obtaining the indication of the first surface may involve identifying the first surface. In some implementations, the first surface is identified manually, e.g., based on gesture, voice, gaze, or other input from a user. A user may point a finger at the approximate center of a wall to identify the wall and the user's gesture may be identified in images captured by outward-facing sensors on the user's device, for example. In some implementations the first surface is identified automatically, e.g., based on one or more criteria. For example, a scene understanding may be determined by evaluating sensor data (e.g., images, depth, etc.) of a physical environment and the scene understanding may be used to identify a surface that has the attributes that are best suited for alignment/portal purposes. Such criteria may include, but are not limited to, the location and orientation of furniture within the physical environment, the size or shape of candidate surfaces, the entries/exits/doors/windows on the candidate surfaces, the user's prior selection of a surface, the lighting in the physical environment, the location of the user or other persons within the physical environment, or the location of potential obstructions between the user's current or expected position within the physical environment and the candidate surfaces.

In some implementations, identifying the first surface involves receiving input via the first device identifying the first surface during the communication session, e.g., at the beginning or initiation stage of a communication session. The method 800 may identify the first surface based on displaying a displayed visualization of a size of a second surface (of a second physical environment) on one or more surfaces in a view of the first physical environment and receiving an input selecting the first surface from amongst the one or more surfaces. For example, if the second surface is 10 feet wide by 8 feet high, a graphic rectangle of this size may be projected onto each of the walls within the first environment so that the first user can visualize and select which wall works best, e.g., for a portal of that size.

At block 804, the method 800 obtains a 3D alignment between a representation of the first physical environment obtained via sensor data of the first device and a representation of a second physical environment obtained via sensor data of a second device. The second physical environment comprises the second device. The alignment aligns a portion of the representation of the first physical environment corresponding to the first surface with a portion of the representation of the second physical environment corresponding to a second surface of the second physical environment.

Obtaining the 3D alignment may be based on one or more identifications or selections of the first surface and/or second surface. Such identifications or selections may be made in any suitable manner such as the exemplary manual or automatic selection techniques described with respect to block 802. Moreover, the identifying of the first surface (e.g., at block 802) and the identifying of the second surface (e.g., at block 804) may use the same or different surface selection techniques, e.g., the first surface may be selected manually while the second surface may be selected automatically.

One or both of the first surface and second surface may be walls, partial walls, windows, doors, dividers, screens, etc.

The method 800 may determine the three-dimensional (3D) alignment (e.g., a 3D positional relationship for room merging purposes) between a first portion of the first physical environment and a second portion of the second physical environment. The alignment aligns the first surface and the second surface. Non-limiting examples of alignments between two portions of different physical environments are illustrated in FIGS. 2C, 2D, 3, 6, 7A, and 7B. The alignment may overlap the selected surface. The alignment may position the portions such that the surfaces have a specified positional relationship, e.g., on planes that are parallel to one another and 1 foot apart.

In some implementations, the 3D alignment is determined based on sizes of the first surface and the second surface.

The 3D alignment may be determined based on additionally aligning horizontal surfaces (e.g., floors) within the first and second physical environments.

The 3D alignment may be determined based on aligning representations of portions of three or more physical environments in the XR environment based on surfaces (e.g., walls) identified in each of the three or more physical environments.

At block 808, the method 800 provides a view of an XR environment during a communication session. The XR environment comprises the representation of the first physical environment and the representation of the second physical environment aligned according to the obtained 3D alignment. FIGS. 4 and 5 illustrate examples of views of an XR environment during a communication session in which portions of different environment are depicted as merged. The first portions and second portions are positioned within an XR environment, aligned according to the determined 3D alignment illustrated in FIGS. 2C, 2D, and 3.

In some implementations, the XR environment represents the first portion and the second portion adjacent to one another and conceptually separated by a portal that replaces at least a portion of the first surface and at least a portion of the second surface. In some implementations, the view is provided to a first user of the first device from a viewpoint position within the XR environment, where the view depicts the first portion of the first physical environment around the viewpoint and the second portion of the second physical environment through a portal positioned based on a position of the first surface in the first physical environment.

The view may exclude a depiction of some or all of the first surface or the second surface. The view may replace sensor data content corresponding to the first surface (and wall hangings) with content depicting the second portion of the second physical environment.

In some implementations, the view depends upon movement (e.g., current position in the first physical environment) of the first device such that movement of the first devices to a different position within the first physical environment changes the viewpoint position within the XR environment.

Some implementations further involve changing the 3D alignment based on user input during the communication session. For example, a user may determine that a given wall is no longer the best wall to use for the portal and provide input to switch the location of a portal to another wall within the physical environment.

The view may be presented based on data obtained prior to or during the communication session. In some implementations, the first and second device stream live image, depth or other data to one another during the communication session to enable one another to produce views of their physical environments as portions of a merged XR environment. In some implementation, at least a portion of the first sensor data or the second sensor data corresponding to the physical environments is obtained prior to the communication session (e.g., during prior room scan(s)) and used to provide the view.

In some implementations, the XR environment is generated based on image, depth, or other sensor data. An XR environment may include one or more 3D models, e.g., point clouds, meshes, or other 3D representations, of furniture, walls, persons, or other objects within the physical environments. Accordingly, the XR environment may include a 3D model (e.g., point cloud, mesh etc.) representing the first portion and the second portion.

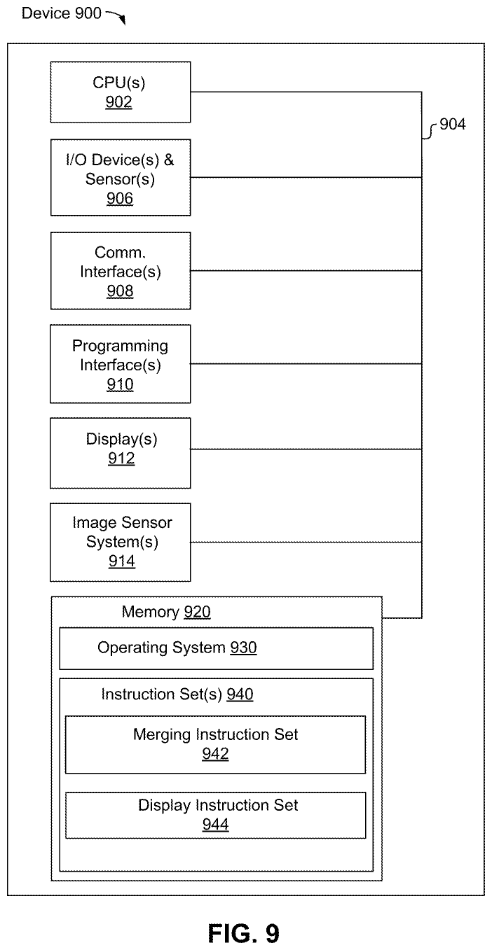

FIG. 9 is a block diagram of electronic device 900. Device 900 illustrates an exemplary device configuration for electronic device 110a or electronic device 110b. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the device 1200 includes one or more processing units 902 (e.g., microprocessors, ASICs, FPGAs, GPUs, CPUs, processing cores, and/or the like), one or more input/output (I/O) devices and sensors 906, one or more communication interfaces 908 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, SPI, I2C, and/or the like type interface), one or more programming (e.g., I/O) interfaces 910, one or more output device(s) 912, one or more interior and/or exterior facing image sensor systems 914, a memory 920, and one or more communication buses 904 for interconnecting these and various other components.

In some implementations, the one or more communication buses 904 include circuitry that interconnects and controls communications between system components. In some implementations, the one or more I/O devices and sensors 906 include at least one of an inertial measurement unit (IMU), an accelerometer, a magnetometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more output device(s) 912 include one or more displays configured to present a view of a 3D environment to the user. In some implementations, the one or more displays 912 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electromechanical system (MEMS), and/or the like display types. In some implementations, the one or more displays correspond to diffractive, reflective, polarized, holographic, etc. waveguide displays. In one example, the device 900 includes a single display. In another example, the device 900 includes a display for each eye of the user.

In some implementations, the one or more output device(s) 912 include one or more audio producing devices. In some implementations, the one or more output device(s) 912 include one or more speakers, surround sound speakers, speaker-arrays, or headphones that are used to produce spatialized sound, e.g., 3D audio effects. Such devices may virtually place sound sources in a 3D environment, including behind, above, or below one or more listeners. Generating spatialized sound may involve transforming sound waves (e.g., using head-related transfer function (HRTF), reverberation, or cancellation techniques) to mimic natural soundwaves (including reflections from walls and floors), which emanate from one or more points in a 3D environment. Spatialized sound may trick the listener's brain into interpreting sounds as if the sounds occurred at the point(s) in the 3D environment (e.g., from one or more particular sound sources) even though the actual sounds may be produced by speakers in other locations. The one or more output device(s) 912 may additionally or alternatively be configured to generate haptics.

In some implementations, the one or more image sensor systems 914 are configured to obtain image data that corresponds to at least a portion of a physical environment. For example, the one or more image sensor systems 914 may include one or more RGB cameras (e.g., with a complimentary metal-oxide-semiconductor (CMOS) image sensor or a charge-coupled device (CCD) image sensor), monochrome cameras, IR cameras, depth cameras, event-based cameras, and/or the like. In various implementations, the one or more image sensor systems 914 further include illumination sources that emit light, such as a flash. In various implementations, the one or more image sensor systems 914 further include an on-camera image signal processor (ISP) configured to execute a plurality of processing operations on the image data.

The memory 920 includes high-speed random-access memory, such as DRAM, SRAM, DDR RAM, or other random-access solid-state memory devices. In some implementations, the memory 920 includes non-volatile memory, such as one or more magnetic disk storage devices, optical disk storage devices, flash memory devices, or other non-volatile solid-state storage devices. The memory 920 optionally includes one or more storage devices remotely located from the one or more processing units 902. The memory 920 comprises a non-transitory computer readable storage medium.

In some implementations, the memory 920 or the non-transitory computer readable storage medium of the memory 920 stores an optional operating system 930 and one or more instruction set(s) 940. The operating system 930 includes procedures for handling various basic system services and for performing hardware dependent tasks. In some implementations, the instruction set(s) 940 include executable software defined by binary information stored in the form of electrical charge. In some implementations, the instruction set(s) 940 are software that is executable by the one or more processing units 902 to carry out one or more of the techniques described herein.

The instruction set(s) 940 include a merging instruction set 942 configured to, upon execution, merge physical environment spaces as described herein. The instruction set(s) 940 further include a display instruction set 944 configured to, upon execution, generate views of merged spaces as described herein. The instruction set(s) 940 may be embodied as a single software executable or multiple software executables.

Although the instruction set(s) 940 are shown as residing on a single device, it should be understood that in other implementations, any combination of the elements may be located in separate computing devices. Moreover, FIG. 9 is intended more as functional description of the various features which are present in a particular implementation as opposed to a structural schematic of the implementations described herein. As recognized by those of ordinary skill in the art, items shown separately could be combined and some items could be separated. The actual number of instructions sets and how features are allocated among them may vary from one implementation to another and may depend in part on the particular combination of hardware, software, and/or firmware chosen for a particular implementation.

It will be appreciated that the implementations described above are cited by way of example, and that the present invention is not limited to what has been particularly shown and described hereinabove. Rather, the scope includes both combinations and sub combinations of the various features described hereinabove, as well as variations and modifications thereof which would occur to persons skilled in the art upon reading the foregoing description and which are not disclosed in the prior art.

As described above, one aspect of the present technology is the gathering and use of sensor data that may include user data to improve a user's experience of an electronic device. The present disclosure contemplates that in some instances, this gathered data may include personal information data that uniquely identifies a specific person or can be used to identify interests, traits, or tendencies of a specific person. Such personal information data can include movement data, physiological data, demographic data, location-based data, telephone numbers, email addresses, home addresses, device characteristics of personal devices, or any other personal information.

The present disclosure recognizes that the use of such personal information data, in the present technology, can be used to the benefit of users. For example, the personal information data can be used to improve the content viewing experience. Accordingly, use of such personal information data may enable calculated control of the electronic device. Further, other uses for personal information data that benefit the user are also contemplated by the present disclosure.

The present disclosure further contemplates that the entities responsible for the collection, analysis, disclosure, transfer, storage, or other use of such personal information and/or physiological data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates implementations in which users selectively block the use of, or access to, personal information data. That is, the present disclosure contemplates that hardware or software elements can be provided to prevent or block access to such personal information data. For example, in the case of user-tailored content delivery services, the present technology can be configured to allow users to select to “opt in” or “opt out” of participation in the collection of personal information data during registration for services. In another example, users can select not to provide personal information data for targeted content delivery services. In yet another example, users can select to not provide personal information, but permit the transfer of anonymous information for the purpose of improving the functioning of the device.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences or settings based on non-personal information data or a bare minimum amount of personal information, such as the content being requested by the device associated with a user, other non-personal information available to the content delivery services, or publicly available information.

In some embodiments, data is stored using a public/private key system that only allows the owner of the data to decrypt the stored data. In some other implementations, the data may be stored anonymously (e.g., without identifying and/or personal information about the user, such as a legal name, username, time and location data, or the like). In this way, other users, hackers, or third parties cannot determine the identity of the user associated with the stored data. In some implementations, a user may access their stored data from a user device that is different than the one used to upload the stored data. In these instances, the user may be required to provide login credentials to access their stored data.

Numerous specific details are set forth herein to provide a thorough understanding of the claimed subject matter. However, those skilled in the art will understand that the claimed subject matter may be practiced without these specific details. In other instances, methods apparatuses, or systems that would be known by one of ordinary skill have not been described in detail so as not to obscure claimed subject matter.

Unless specifically stated otherwise, it is appreciated that throughout this specification discussions utilizing the terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more implementations of the present subject matter. Any suitable programming, scripting, or other type of language or combinations of languages may be used to implement the teachings contained herein in software to be used in programming or configuring a computing device.

Implementations of the methods disclosed herein may be performed in the operation of such computing devices. The order of the blocks presented in the examples above can be varied for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or value beyond those recited. Headings, lists, and numbering included herein are for ease of explanation only and are not meant to be limiting.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

The foregoing description and summary of the invention are to be understood as being in every respect illustrative and exemplary, but not restrictive, and the scope of the invention disclosed herein is not to be determined only from the detailed description of illustrative implementations but according to the full breadth permitted by patent laws. It is to be understood that the implementations shown and described herein are only illustrative of the principles of the present invention and that various modification may be implemented by those skilled in the art without departing from the scope and spirit of the invention.

What is claimed is:

1. A method comprising:
at a first device having a processor:
obtaining an indication of a first surface of a first physical environment, the first physical environment comprising the first device;
obtaining a three-dimensional (3D) alignment between a representation of the first physical environment obtained via sensor data of the first device and a representation of a second physical environment obtained via sensor data of a second device, the second physical environment comprising the second device, wherein the alignment aligns a portion of the representation of the first physical environment corresponding to the first surface with a portion of the representation of the second physical environment corresponding to a second surface of the second physical environment; and
providing a view of an extended reality (XR) environment during a communication session, the XR environment comprising the representation of the first physical environment and the representation of the second physical environment aligned according to the obtained 3D alignment.

2. The method of claim 1, wherein the first surface and second surface are walls.

3. The method of claim 1, wherein the 3D alignment positions at least a portion of the portion of the representation of the first physical environment corresponding to the first surface parallel to at least a portion of the portion of the representation of the second physical environment corresponding to the second surface.

4. The method of claim 1, wherein the view is provided by the first device from a viewpoint position within the XR environment, wherein the view depicts:
the representation of the first physical environment around the viewpoint; and
the representation of the second physical environment through a portal positioned based on a position of the first surface in the first physical environment.

5. The method of claim 4, wherein the view excludes a depiction of at least a portion of the portion of the representation of the first physical environment corresponding to the first surface.

6. The method of claim 1, wherein obtaining the indication of the first surface comprises:
displaying a visualization of a size of the second surface on one or more surfaces in a view of the first physical environment; and
receiving an input selecting the first surface from amongst the one or more surfaces.

7. The method of claim 1, wherein obtaining the 3D alignment is based on sizes of the first surface and the second surface and further based on aligning horizontal surfaces within the representations of the first and second physical environments.

8. The method of claim 1 further comprising aligning representations of three or more physical environments in the XR environment based on walls identified in each of the three or more physical environments.

9. A system comprising:
a non-transitory computer-readable storage medium; and
one or more processors coupled to the non-transitory computer-readable storage medium, wherein the non-transitory computer-readable storage medium comprises program instructions that, when executed on the one or more processors, cause the system to perform operations comprising:
obtaining an indication of a first surface of a first physical environment, the first physical environment comprising the first device;
obtaining a three-dimensional (3D) alignment between a representation of the first physical environment obtained via sensor data of the first device and a representation of a second physical environment obtained via sensor data of a second device, the second physical environment comprising the second device, wherein the alignment aligns a portion of the representation of the first physical environment corresponding to the first surface with a portion of the representation of the second physical environment corresponding to a second surface of the second physical environment; and
providing a view of an extended reality (XR) environment during a communication session, the XR environment comprising the representation of the first physical environment and the representation of the second physical environment aligned according to the obtained 3D alignment.

10. The system of claim 9, wherein the first surface and second surface are walls.

11. The system of claim 9, wherein the 3D alignment positions at least a portion of the portion of the representation of the first physical environment corresponding to the first surface parallel to at least a portion of the portion of the representation of the second physical environment corresponding to the second surface.

12. The system of claim 9, wherein the view is provided by the first device from a viewpoint position within the XR environment, wherein the view depicts:
the representation of the first physical environment around the viewpoint; and
the representation of the second physical environment through a portal positioned based on a position of the first surface in the first physical environment.

13. The system of claim 12, wherein the view excludes a depiction of at least a portion of the portion of the representation of the first physical environment corresponding to the first surface.

14. The system of claim 9, wherein obtaining the indication of the first surface comprises:
displaying a visualization of a size of the second surface on one or more surfaces in a view of the first physical environment; and
receiving an input selecting the first surface from amongst the one or more surfaces.

15. The system of claim 9, wherein obtaining the 3D alignment is based on sizes of the first surface and the second surface and further based on aligning horizontal surfaces within the representations of the first and second physical environments.

16. The system of claim 9, wherein the operations further comprise aligning representations of three or more physical environments in the XR environment based on walls identified in each of the three or more physical environments.

17. A non-transitory computer-readable storage medium storing program instructions executable via one or more processors to perform operations comprising:
obtaining an indication of a first surface of a first physical environment, the first physical environment comprising the first device;
obtaining a three-dimensional (3D) alignment between a representation of the first physical environment obtained via sensor data of the first device and a representation of a second physical environment obtained via sensor data of a second device, the second physical environment comprising the second device, wherein the alignment aligns a portion of the representation of the first physical environment corresponding to the first surface with a portion of the representation of the second physical environment corresponding to a second surface of the second physical environment; and
providing a view of an extended reality (XR) environment during a communication session, the XR environment comprising the representation of the first physical environment and the representation of the second physical environment aligned according to the obtained 3D alignment.

18. The non-transitory computer-readable storage medium of claim 17, wherein the first surface and second surface are walls.

19. The non-transitory computer-readable storage medium of claim 17, wherein the 3D alignment positions at least a portion of the portion of the representation of the first physical environment corresponding to the first surface parallel to at least a portion of the portion of the representation of the second physical environment corresponding to the second surface.

20. The non-transitory computer-readable storage medium of claim 17, wherein the view is provided by the first device from a viewpoint position within the XR environment, wherein the view depicts:
the representation of the first physical environment around the viewpoint; and
the representation of the second physical environment through a portal positioned based on a position of the first surface in the first physical environment.

21. The non-transitory computer-readable storage medium of claim 20, wherein the view excludes a depiction of at least a portion of the portion of the representation of the first physical environment corresponding to the first surface.

22. The non-transitory computer-readable storage medium of claim 17, wherein obtaining the indication of the first surface comprises:
displaying a visualization of a size of the second surface on one or more surfaces in a view of the first physical environment; and
receiving an input selecting the first surface from amongst the one or more surfaces.

23. The non-transitory computer-readable storage medium of claim 17, wherein obtaining the 3D alignment is based on sizes of the first surface and the second surface and further based on aligning horizontal surfaces within the representations of the first and second physical environments.

24. The non-transitory computer-readable storage medium of claim 17, wherein the operations further comprise aligning representations of three or more physical environments in the XR environment based on walls identified in each of the three or more physical environments.
